(19) United States
(12) Patent Application Publication
(10) Pub. No.: US 2008/0120370 A1
(43) Pub. Date: May 22, 2008

(54) Virtual Meeting Server Discovery

(76) Inventors: Brian Chan, Palo Alto, CA (US); Steve Nelson, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/562,880

(22) Filed: Nov. 22, 2006

(51) Int. Cl. G06F 15/16

(52) U.S. Cl. 709/204

(57) ABSTRACT

Apparatus having corresponding methods and computer-readable media comprises an input circuit to receive registration messages from virtual meeting servers, wherein each registration message comprises a network address of the respective virtual meeting server and an identification string for the respective virtual meeting server; a memory to store an association for each of the virtual meeting servers between the respective network addresses and the respective identification strings; wherein the input circuit receives virtual meeting invitation acceptance messages each comprising one of the identification strings; a processor to select the network addresses associated with the identification strings in the virtual meeting invitation acceptance messages; and an output circuit to transmit a redirect message in response to each of the virtual meeting invitation acceptance messages, wherein each of the redirect messages comprises the network address associated with the identification string in the corresponding virtual meeting invitation acceptance message.

### BACKGROUND

The present invention relates generally to data communications networks, servers, and clients. More particularly, the present invention relates to virtual meetings such as videoconferences.

FIG. 1 shows a prior art virtual meeting system 100. Virtual meeting system 100 comprises one or more virtual meeting servers 102 and a plurality of virtual meeting clients 104A-N connected by a network 106. When a virtual meeting is to be hosted by virtual meeting server 102, virtual meeting invitations are sent to the virtual meeting clients 104 chosen to participate in the virtual meeting. To enable virtual meeting clients 104 to locate virtual meeting server 102, each virtual meeting invitation includes the network address of virtual meeting server 102, which is generally in the form of an Internet Protocol (IP) address.

However, in some network environments, the network addresses of virtual meeting server(s) 102 are in flux. For example, network server(s) may obtain their IP addresses using Dynamic Host Configuration Protocol (DHCP). In such network environments, the IP address of each network server 102 is dynamic, so that the IP address can change after the virtual meeting invitations are sent, but before the virtual meeting begins. When this happens, the virtual meeting clients 104 invited to the virtual meeting may be unable to locate the virtual meeting server 102 hosting the virtual meeting, and will therefore be unable to participate in the virtual meeting.

### SUMMARY

In general, in one aspect, the invention features an apparatus comprising: an input circuit to receive registration messages from virtual meeting servers, wherein each registration message comprises a network address of the respective virtual meeting server and an identification string for the respective virtual meeting server; a memory to store an association for each of the virtual meeting servers between the respective network addresses and the respective identification strings; wherein the input circuit receives virtual meeting invitation acceptance messages, wherein each virtual meeting invitation acceptance message comprises one of the identification strings; a processor to select the network addresses associated with the identification strings in the virtual meeting invitation acceptance messages; and an output circuit to transmit a redirect message in response to each of the virtual meeting invitation acceptance messages, wherein each of the redirect messages comprises the network address associated with the identification string in the corresponding virtual meeting invitation acceptance message.

In some embodiments, the network address comprises: a dynamic Internet Protocol (IP) address. In some embodiments, when one of the registration messages comprises an identification string for one of the virtual meeting servers having a corresponding one of the associations stored in the memory, the processor replaces the dynamic IP address in the one of the associations with the dynamic IP address of the virtual meeting server from the one of the registration messages. In some embodiments, when one of the registration messages comprises an identification string for one of the virtual meeting servers not having a corresponding one of the associations stored in the memory, the processor stores, in the memory, an association between the dynamic IP address of the virtual meeting server from the one of the registration messages and the identification strings from the one of the registration messages. In some embodiments, the virtual meeting comprises: a videoconference.

In general, in one aspect, the invention features computer-readable media embodying instructions executable by a computer to perform a method comprising: receiving registration messages from virtual meeting servers, wherein each registration message comprises a network address of the respective virtual meeting server and an identification string for the respective virtual meeting server; storing an association for each of the virtual meeting servers between the respective network addresses and the respective identification strings; receiving virtual meeting invitation acceptance messages, wherein each virtual meeting invitation acceptance message comprises one of the identification strings; selecting the network addresses associated with the identification strings in the virtual meeting invitation acceptance messages; and transmitting a redirect message in response to each of the virtual meeting invitation acceptance messages, wherein each of the redirect messages comprises the network address associated with the identification string in the corresponding virtual meeting invitation acceptance message.

In some embodiments, the network address comprises: a dynamic Internet Protocol (IP) address. Some embodiments comprise when one of the registration messages comprises an identification string for one of the virtual meeting servers having a corresponding one of the associations, replacing the dynamic IP address in the one of the associations with the dynamic IP address of the virtual meeting server from the one of the registration messages. Some embodiments comprise when one of the registration messages comprises an identification string for one of the virtual meeting servers not having a corresponding one of the associations, storing an association between the dynamic IP address of the virtual meeting server from the one of the registration messages and the identification strings from the one of the registration messages. In some embodiments, the virtual meeting comprises: a videoconference.

In general, in one aspect, the invention features an apparatus comprising: a processor to host a virtual meeting; and an output circuit to transmit a registration message to a discovery server, wherein the registration message comprises a first network address assigned to the discovery server, a second network address assigned to the apparatus, and an identification string assigned to the apparatus; wherein the output circuit transmits virtual meeting invitation messages to virtual meeting clients, wherein each of the virtual meeting invitation messages comprises an identifier of the virtual meeting, the first network address of the discovery server, and the identification string.

In some embodiments, the first network address comprises a static Internet Protocol (IP) address; and the second network address comprises a dynamic IP address. In some embodiments, the processor generates a uniform resource locator (URL) comprising the identification string, and having the static IP address assigned to the discovery server as the target of the URL; and each of the virtual meeting invitation messages comprises the URL. In some embodiments, the processor determines whether any identification string is assigned to the apparatus, and, when no identification string is assigned to the apparatus, generates a new identification string, and assigns the new identification string to the apparatus. In some embodiments, the virtual meeting comprises: a videoconference. In some embodiments, the apparatus obtains the dynamic IP addresses using Dynamic Host Configuration Protocol (DHCP).

In general, in one aspect, the invention features a computer-readable media embodying instructions executable by a computer to perform a method comprising: hosting a virtual meeting; transmitting a registration message to a discovery server, wherein the registration message comprises a first network address assigned to the discovery server, a second network address assigned to a computer executing the instructions, and an identification string assigned to the computer; and transmitting virtual meeting invitation messages to virtual meeting clients, wherein each of the virtual meeting invitation messages comprises an identifier of the virtual meeting, the first network address of the discovery server, and the identification string.

In some embodiments, the first network address comprises a static Internet Protocol (IP) address; and wherein the second network address comprises a dynamic IP address. In some embodiments, the method further comprises: generating a uniform resource locator (URL) comprising the identification string, and having the static IP address assigned to the discovery server as the target of the URL; wherein each of the virtual meeting invitation messages comprises the URL. In some embodiments, the method further comprises: determining whether any identification string is assigned to the computer, and, when no identification string is assigned to the computer, generates a new identification string, and assigns the new identification string to the computer. In some embodiments, the virtual meeting comprises: a videoconference. In some embodiments, the method further comprises: obtaining the dynamic IP addresses using Dynamic Host Configuration Protocol (DHCP).

In general, in one aspect, the invention features an apparatus comprising: input means for receiving registration messages from virtual meeting servers, wherein each registration message comprises a network address of the respective virtual meeting server and an identification string for the respective virtual meeting server; memory means for storing an association for each of the virtual meeting servers between the respective network addresses and the respective identification strings; wherein the input means receives virtual meeting invitation acceptance messages, wherein each virtual meeting invitation acceptance message comprises one of the identification strings; processor means for selecting the network addresses associated with the identification strings in the virtual meeting invitation acceptance messages; and output means for transmitting a redirect message in response to each of the virtual meeting invitation acceptance messages, wherein each of the redirect messages comprises the network address associated with the identification string in the corresponding virtual meeting invitation acceptance message.

In some embodiments, the network address comprises: a dynamic Internet Protocol (IP) address. In some embodiments, when one of the registration messages comprises an identification string for one of the virtual meeting servers having a corresponding one of the associations stored in the memory, the processor means replaces the dynamic IP address in the one of the associations with the dynamic IP address of the virtual meeting server from the one of the registration messages. In some embodiments, when one of the registration messages comprises an identification string for one of the virtual meeting servers not having a corresponding one of the associations stored in the memory, the processor means stores, in the memory means, an association between the dynamic IP address of the virtual meeting server from the one of the registration messages and the identification strings from the one of the registration messages. In some embodiments, the virtual meeting comprises: a videoconference.

In general, in one aspect, the invention features a method comprising: receiving registration messages from virtual meeting servers, wherein each registration message comprises a network address of the respective virtual meeting server and an identification string for the respective virtual meeting server; storing an association for each of the virtual meeting servers between the respective network addresses and the respective identification strings; receiving virtual meeting invitation acceptance messages, wherein each virtual meeting invitation acceptance message comprises one of the identification strings; selecting the network addresses associated with the identification strings in the virtual meeting invitation acceptance messages; and transmitting a redirect message in response to each of the virtual meeting invitation acceptance messages, wherein each of the redirect messages comprises the network address associated with the identification string in the corresponding virtual meeting invitation acceptance message.

In some embodiments, the network address comprises: a dynamic Internet Protocol (IP) address. Some embodiments comprise, when one of the registration messages comprises an identification string for one of the virtual meeting servers having a corresponding one of the associations, replacing the dynamic IP address in the one of the associations with the dynamic IP address of the virtual meeting server from the one of the registration messages. Some embodiments comprise, when one of the registration messages comprises an identification string for one of the virtual meeting servers not having a corresponding one of the associations, storing an association between the dynamic IP address of the virtual meeting server from the one of the registration messages and the identification strings from the one of the registration messages. In some embodiments, the virtual meeting comprises: a videoconference.

In general, in one aspect, the invention features an apparatus comprising: processor means for hosting a virtual meeting; and output means for transmitting a registration message to a discovery server, wherein the registration message comprises a first network address assigned to the discovery server, a second network address assigned to the apparatus, and an identification string assigned to the apparatus; wherein the output means transmits virtual meeting invitation messages to virtual meeting clients, wherein each of the virtual meeting invitation messages comprises an identifier of the virtual meeting, the first network address of the discovery server, and the identification string.

In some embodiments, the first network address comprises a static Internet Protocol (IP) address; and the second network address comprises a dynamic IP address. In some embodiments, the processor means generates a uniform resource locator (URL) comprising the identification string, and having the static IP address assigned to the discovery server as the target of the URL; and wherein each of the virtual meeting invitation messages comprises the URL. In some embodiments, the processor means determines whether any identification string is assigned to the apparatus, and, when no identification string is assigned to the apparatus, generates a new identification string, and assigns the new identification string to the apparatus. In some embodiments, the virtual meeting comprises: a videoconference. In some embodiments, the apparatus obtains the dynamic IP addresses using Dynamic Host Configuration Protocol (DHCP).

In general, in one aspect, the invention features a method comprising: hosting a virtual meeting; transmitting a registration message to a discovery server, wherein the registration message comprises a first network address assigned to the discovery server, a second network address assigned to an apparatus executing the method, and an identification string assigned to the apparatus; and transmitting virtual meeting invitation messages to virtual meeting clients, wherein each of the virtual meeting invitation messages comprises an identifier of the virtual meeting, the first network address of the discovery server, and the identification string.

In some embodiments, the first network address comprises a static Internet Protocol (IP) address; and the second network address comprises a dynamic IP address. Some embodiments comprise generating a uniform resource locator (URL) comprising the identification string, and having the static IP address assigned to the discovery server as the target of the URL; wherein each of the virtual meeting invitation messages comprises the URL. Some embodiments comprise determining whether any identification string is assigned to the apparatus, and, when no identification string is assigned to the apparatus, generates a new identification string, and assigns the new identification string to the apparatus. In some embodiments, the virtual meeting comprises: a videoconference. Some embodiments comprise obtaining the dynamic IP addresses using Dynamic Host Configuration Protocol (DHCP).

The details of one or more implementations are set forth in the accompanying drawings and the description below. Other features will be apparent from the description and drawings, and from the claims.

### DESCRIPTION OF DRAWINGS

FIG. 1 shows a prior art virtual meeting system.

FIG. 2 shows a virtual meeting system according to some embodiments of the present invention.

FIG. 3 shows a flow diagram for the virtual meeting system of FIG. 2.

FIG. 4 shows a configuration process for a virtual meeting server according to some embodiments of the present invention.

FIG. 5 shows an example screenshot of a web form for virtual meeting server configuration.

FIG. 6 shows an example screenshot of an updated configuration page for a virtual meeting server displaying the configured static IP address of a discovery server.

FIG. 7 shows a registration process according to some embodiments of the present invention.

FIG. 8 shows an example screenshot of a virtual meeting invitation email comprising such a URL.

FIG. 9 shows a redirect process for a discovery server according to some embodiments of the present invention.

FIGS. 10-19 illustrate a Multi-chat-session Management Console.

FIGS. 20-21 illustrate a Master-Slave VoIP Data Management System Protocol.

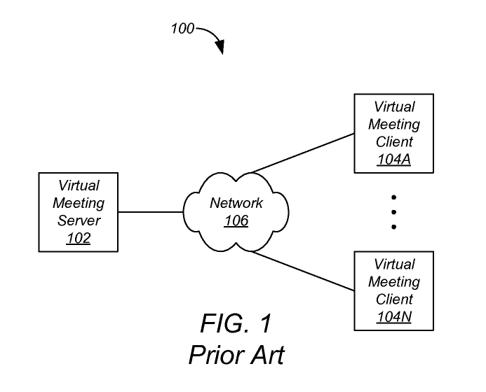

The leading digit(s) of each reference numeral used in this specification indicates the number of the drawing in which the reference numeral first appears.

### DETAILED DESCRIPTION

As used herein, the terms “client” and “server” generally refer to an electronic device or mechanism, and the term “message” generally refers to an electronic signal representing a digital message. As used herein, the term “mechanism” refers to hardware, software, or any combination thereof. These terms are used to simplify the description that follows. The clients, servers, and mechanisms described herein can be implemented on any standard general-purpose computer, or can be implemented as specialized devices.

Embodiments of the present invention are discussed in terms of videoconference meetings. However, embodiments of the present invention apply as well to other sorts of virtual meetings that may or may not include video streams, as will be apparent to one skilled in the relevant arts based on the disclosure and teachings provided herein.

Embodiments of the present invention provide discovery servers having static network addresses, such as static Internet Protocol (IP) addresses, and virtual meeting servers having dynamic network addresses, such as dynamic IP addresses. For clarity, embodiments of the present invention are described in terms of IP addresses. However, embodiments of the present invention are readily applicable to other sorts of network addresses, as will be apparent to one skilled in the relevant arts based on the disclosure and teachings provided herein.

According to embodiments of the present invention, each virtual meeting server “registers” with the discovery server whenever the IP address of the virtual meeting server changes. For example, In a DHCP network environment, when a virtual meeting server reboots, it obtains a new dynamic IP address using DHCP. The virtual meeting server then registers the new IP address with the discovery server, along with a unique identifier of the virtual meeting server. Invitations to virtual meetings hosted by the virtual meeting servers include the unique identifier of the virtual meeting server hosting the virtual meeting, and the static IP address of the discovery server, for example combined in the form of a uniform resource locator (URL).

To join a virtual meeting, a user of a virtual meeting client simply activates the URL, which causes a message to be sent to the discovery server including the unique identifier of the virtual meeting server hosting the virtual meeting. The discovery server applies the unique identifier to a discovery table that contains associations, created during the registration process, between the unique identifiers and dynamic IP addresses of the virtual meeting servers. Having obtained the dynamic IP address of the virtual meeting server hosting the virtual meeting, the discovery server redirects the virtual meeting client to the virtual meeting server.

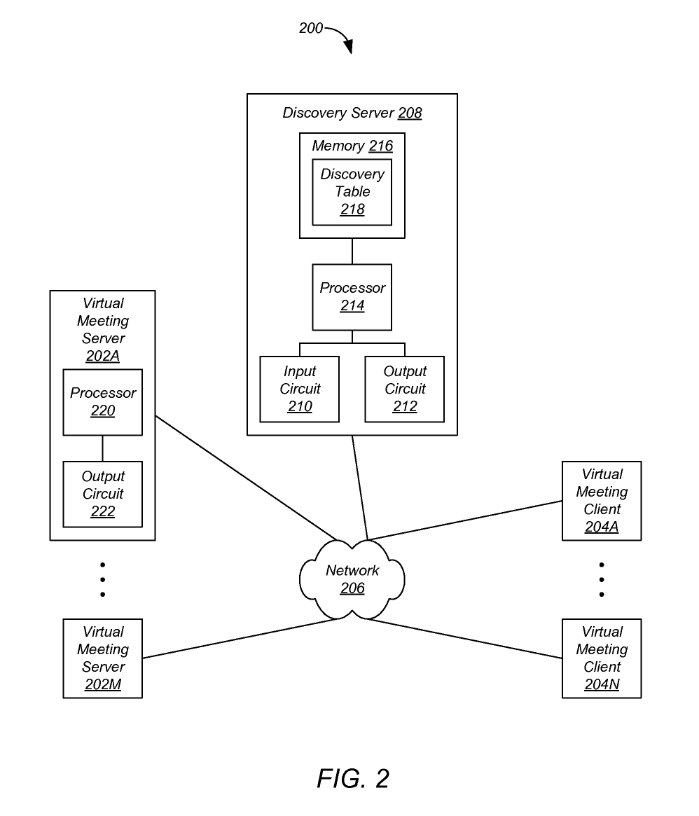

FIG. 2 shows a virtual meeting system 200 according to some embodiments of the present invention. Virtual meeting system 200 comprises one or more virtual meeting servers 202A-M, a plurality of virtual meeting clients 204A-N, and a discovery server 208 connected by a network 206. Each virtual meeting server 202 comprises a processor 220 and an output circuit 222. Discovery server 208 comprises an input circuit 210, an output circuit 212, a processor 214, and a memory 216 to store a discovery table 218.

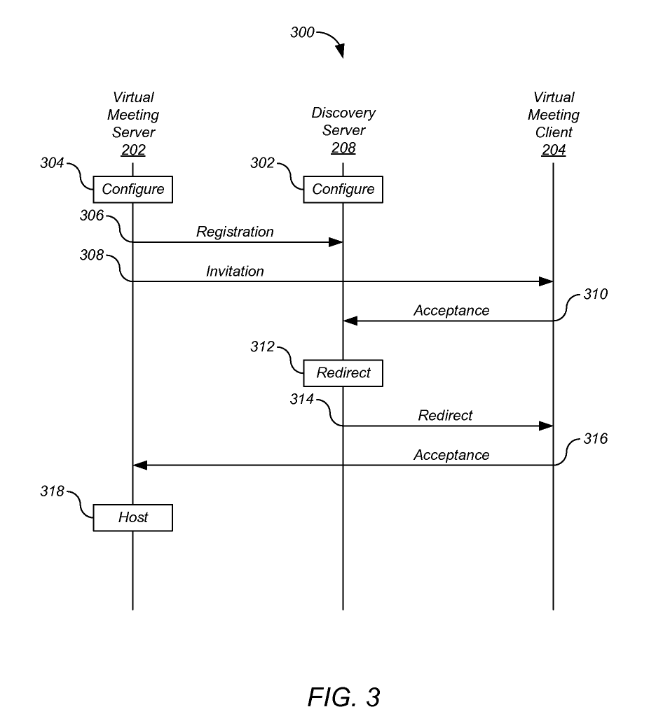

FIG. 3 shows a flow diagram 300 for the virtual meeting system 200 of FIG. 2.

Although in the described embodiments, the elements of flow diagram 300 are presented in one arrangement, other embodiments may feature other arrangements, as will be apparent to one skilled in the relevant arts based on the disclosure and teachings provided herein.

Referring to FIG. 3, discovery server 208 is configured by assigning a static IP address to discovery server 208 (step 302). For example, a system administrator can assign the static IP address during deployment of discovery server 208.

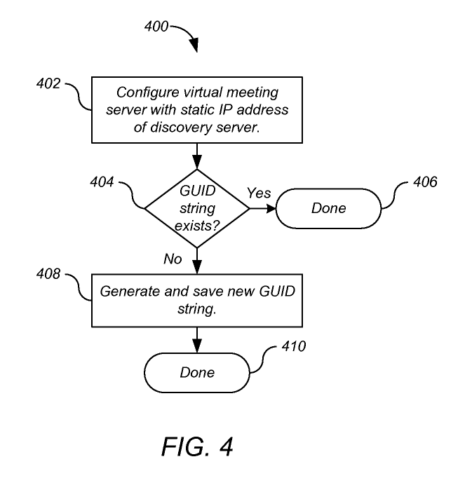

Virtual meeting servers 202 are also configured (step 304). FIG. 4 shows a configuration process 400 for a virtual meeting server 202 according to some embodiments of the present invention. Although in the described embodiments, the elements of process 400 are presented in one arrangement, other embodiments may feature other arrangements, as will be apparent to one skilled in the relevant arts based on the disclosure and teachings provided herein.

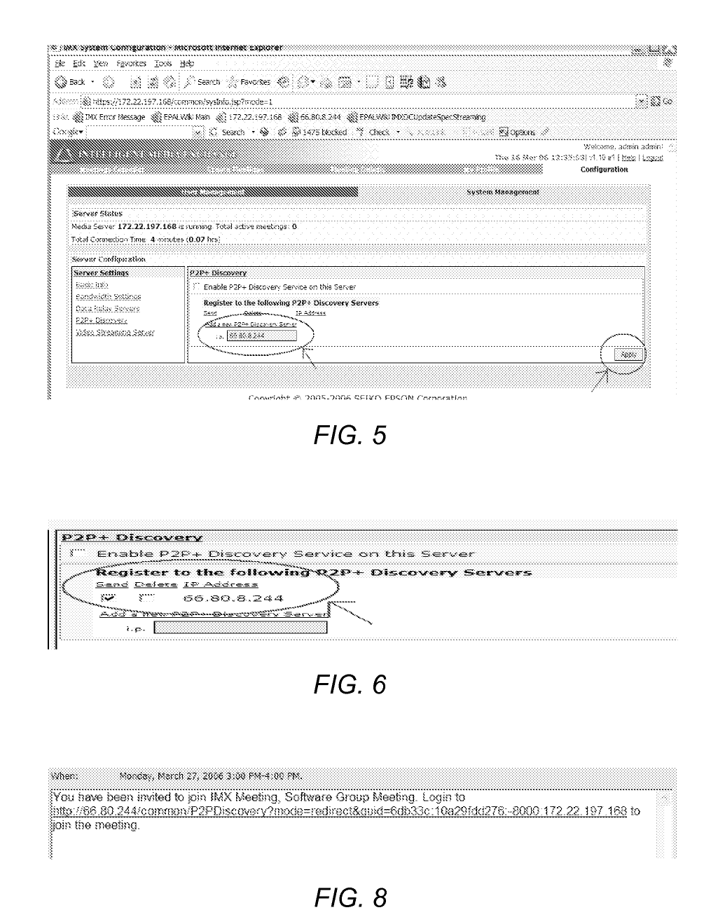

Referring to FIG. 4, virtual meeting server 202 is configured with the static IP address of discovery server 208 (step 402). For example, during deployment of virtual meeting server 202, a system administrator can enter the static IP address of discovery server 208. A web interface can be used for configuration. FIG. 5 shows an example screenshot of a web form for virtual meeting server 202 configuration. After submitting the web form, the static IP address of the discovery server 208 is stored on the virtual meeting server 202. FIG. 6 shows an example screenshot of an updated configuration page for virtual meeting server 202 displaying the configured static IP address of discovery server 208.

Referring again to FIG. 4, virtual meeting server 202 determines whether a globally unique identifier (GUID) string has been configured for the virtual meeting server 202 (step 404). In some embodiments, a system administrator can enter the GUID string during deployment of virtual meeting server 202. If a GUID string exists for virtual meeting server 202, process 400 is done (step 406).

If no GUID string exists for the virtual meeting server 202 (step 404), the virtual meeting server 202 generates and saves a new GUID string (step 408). Then process 400 is done (step 410). Numerous methods exist to guarantee, to a sufficient degree, the uniqueness of such a string within a group of networked computers, as is well-known in the relevant arts.

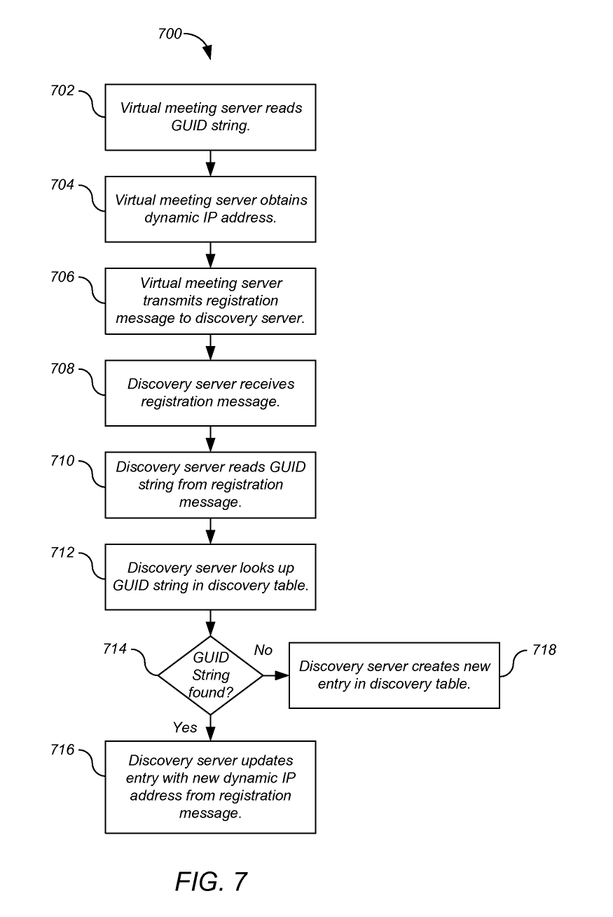

Referring again to FIG. 3, virtual meeting server 202 registers with discovery server 208 (step 306). FIG. 7 shows a registration process 700 according to some embodiments of the present invention. Although in the described embodiments, the elements of process 700 are presented in one arrangement, other embodiments may feature other arrangements, as will be apparent to one skilled in the relevant arts based on the disclosure and teachings provided herein.

Referring to FIG. 7, virtual meeting server 202 reads the GUID string (step 702). Virtual meeting server 202 also obtains a dynamic IP address (step 704), for example by using DHCP or the like. Virtual meeting server 202 then registers with discovery server 208 by causing output circuit 222 to transmit a registration message to discovery server 208 (step 706). The registration message includes the dynamic IP address of the virtual meeting server 202, for example as a source address of a packet, and the GUID string assigned to the virtual meeting server 202, for example as the payload of a packet. The registration message can also include the static IP address assigned to discovery server 208, for example as the destination address of a packet. The registration message can be a hyper-text transfer protocol (HTTP) request message or the like.

Input circuit 210 of discovery server 208 receives the registration message (step 708). Processor 214 of discovery server 208 reads the GUID string from the registration message (step 710), and looks up the GUID string in discovery table 218 (step 712). An example discovery table 218 is shown below as Table 1.

TABLE 1

| GUID String | Dynamic IP Address |
|---|---|
| String 1 | Server 1 IP Address |
| String 2 | Server 2 IP Address |
| . . . | . . . |
| String N | Server N IP Address |

If an entry for the GUID string is found in discovery table 218 (step 714), discovery server 208 updates that entry with the new dynamic IP address from the registration message (step 716). Otherwise, discovery server 208 creates a new entry in discovery table 218 associating the GUID string with the dynamic IP address from the registration message (step 718).

In some embodiments, registration process 700 includes an authentication process where discovery server 208 authenticates virtual meeting server 202. The authentication process can include any sort of authentication means, such as the use of a shared password and the like. If the authentication process fails, discovery server 208 does not allow virtual meeting server 202 to register. This authentication step prevents attackers from spoofing legitimate virtual meeting servers 202.

Referring again to FIG. 3, after registration (step 306), virtual meeting server 202 can transmit virtual meeting invitations to a virtual meeting to be hosted by virtual meeting server 202 (step 308). In particular, output circuit 222 of virtual meeting server 202 transmits virtual meeting invitation messages to the virtual meeting clients 204 chosen to participate in the virtual meeting. Each of the virtual meeting invitation messages includes an identifier of the virtual meeting, the static IP address of discovery server 208, and the GUID string of the virtual meeting server 202 hosting the virtual meeting. When the virtual meeting invitation is accepted, virtual meeting client 204 sends an acceptance message to discovery server 208 (step 310). The acceptance message includes the GUID string received in the virtual meeting invitation.

In some embodiments, each virtual meeting invitation is an email message including a URL that includes a link to discovery server 208 and passes the GUID string as a parameter to discovery server 208. FIG. 8 shows an example screenshot of a virtual meeting invitation email comprising such a URL. When the invited meeting participant clicks on the URL, client 204 sends an acceptance message, such as an HTTP request message, to discovery server 208.

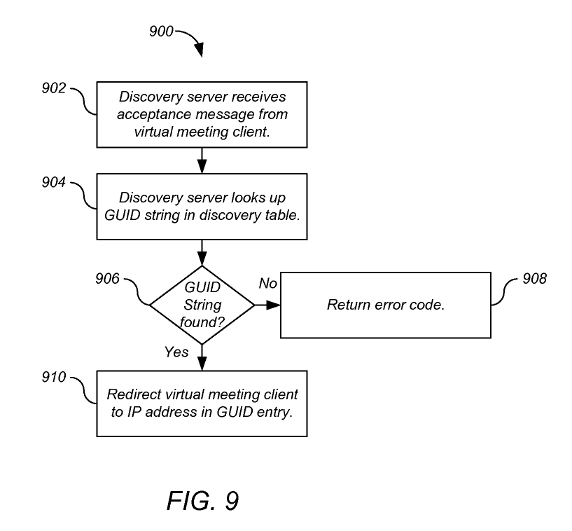

Discovery server 208 executes a redirect process to redirect acceptance messages to the appropriate virtual meeting server 202 (step 312). FIG. 9 shows a redirect process 900 for a discovery server 208 according to some embodiments of the present invention. Although in the described embodiments, the elements of process 900 are presented in one arrangement, other embodiments may feature other arrangements, as will be apparent to one skilled in the relevant arts based on the disclosure and teachings provided herein.

Referring to FIG. 9, input circuit 210 of discovery server 208 receives an acceptance message from a virtual meeting client 204 (step 902). In some embodiments, discovery server 208 authenticates the acceptance message as coming from a legitimate meeting participant.

Discovery server 208 reads the GUID string from the acceptance message, and looks up the GUID string in discovery table 218 (step 904). If no entry exists in discovery table 218 for the GUID string (step 906), discovery server 208 can perform an action such as returning an error code (step 908) or the like. But when an entry is found for the GUID string in discovery table (step 906), discovery server 208 redirects the virtual meeting client 204 to the IP address in the entry (step 910) which, is the dynamic IP address previously registered by the appropriate virtual meeting server 202. For example, referring again to FIG. 3, output circuit 212 of discovery server 208 transmits a redirect message (step 314), such as an HTTP response message or the like, to the virtual meeting client 204, where the response message includes the dynamic IP address of the virtual meeting server 202.

Virtual meeting client 204 then connects to the virtual meeting server 202 using another acceptance message (step 316). For example, virtual meeting client 204 can send an HTTP request message to the dynamic IP address received in the redirect message.

Processor 220 of virtual meeting server 202 then hosts the virtual meeting (step 318). For example, virtual meeting server can act as a repository for virtual meeting data and meeting participant information. Virtual meeting server 202 can also serve as a hub or router for video, audio and data streams and the like.

Some embodiments comprise a Multi-chat-session Management Console. In some embodiments, a user interface for a plurality of concurrent chat sessions each associated with a participant, the user interface comprising: a managed chat area to display a plurality of full-scale chat windows each representing one of the chat sessions and each comprising a first participant field to identify the participant associated with the respective chat session, a first chat pane to display one or more messages associated with the respective chat session, a new message pane to receive text for a new message to be sent for the respective chat session, and a send button to send the new message when activated; and a message queue panel comprising a plurality of chat listings each representing one of the chat sessions not represented by one of the full-scale chat windows in the managed chat area, wherein each chat listing comprises a second participant field to identify the participant associated with the respective chat session, and a second chat pane to display part of a message associated with the respective chat session, and a disconnect button to disconnect the respective chat session when activated; wherein, when one of the full-scale chat windows in the managed chat area is minimized, a new one of the chat listings is created in the message queue panel to represent the chat session represented by the minimized full-scale chat window; and wherein, when one of the chat listings in the message queue panel is maximized, a new one of the full-scale chat windows is created in the managed chat area to represent the chat session represented by the maximized chat listing.

Some embodiments comprise the user interface, wherein each of the participants is associated with one or more videoconferences, further comprising: a participant connection status panel comprising, for each participant, a status indicator representing a status of a connection of the participant with a respective one of the videoconferences. Some embodiments comprise the user interface, wherein the participant connection status panel further comprises: a chat button for each participant to initiate a chat session with the participant when activated. Some embodiments comprise a quick text view panel to display one or more recent messages associated with a selected one of the chat listings in the message queue panel. In some embodiments, the messages in the quick text view panel are displayed in a plurality of colors each corresponding to a respective author. Some embodiments comprise a quick layout toolbar comprises a plurality of buttons each to create a respective layout of the full-scale chat windows in the managed chat area when activated.

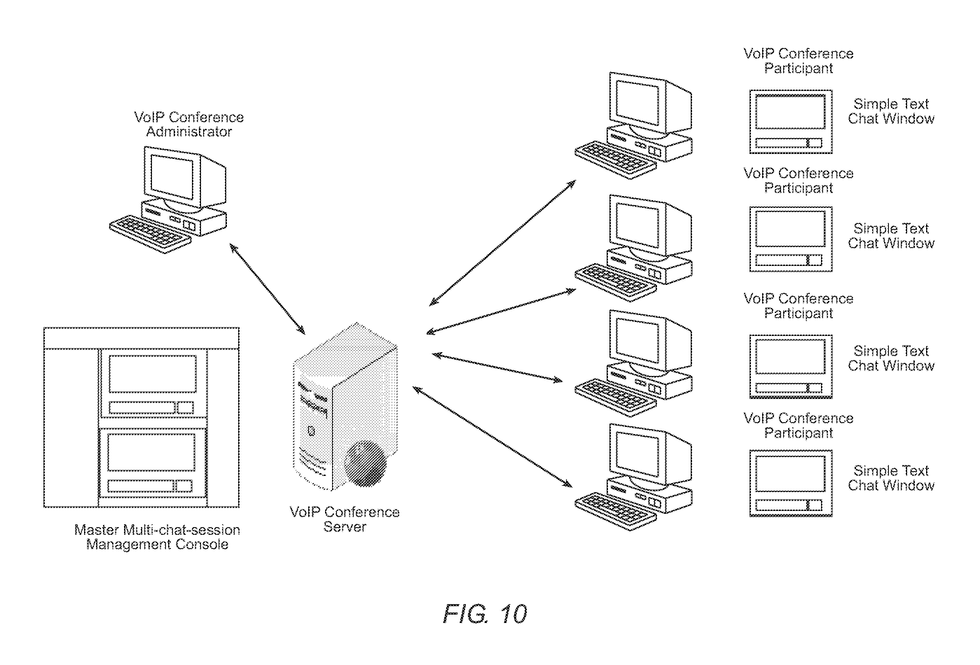

In a managed IP/Internet Video Conference system such as that shown in FIG. 10, many individual participants may want to text chat with the meeting administrator privately for various issues. However, for the conference administrator, handling multiple chat sessions with up to 40-50 (or more) users at once can be overwhelming. It is especially true if each individual chat session has its own independent text chat popup window/dialog. Imagine 40 unmanaged text chat windows all over the administrator's desktop at once. A multi-chat-session user interface that helps meeting administrator coordinate multiple concurrent text chat sessions better is disclosed below.

A new application user interface is described that helps system administrator coordinate/handle multiple text chat sessions concurrently. One person can hardly manage more than 4 concurrently active text-chat sessions. However, the administrator needs a way to be informed of all of the latest chat requests and messages. In addition, the administrator also needs a way to put away an existing chat dialog box and replace it with a different one.

In this multi-chat-session management console, the administrator can manage all of his/her chat sessions on one application window. The side panels help the administrator switch between different chat sessions quickly. The quick layout buttons helps the administrator to quickly arrange the user interface for 1, 2, 3, or 4 managed chat sessions at once.

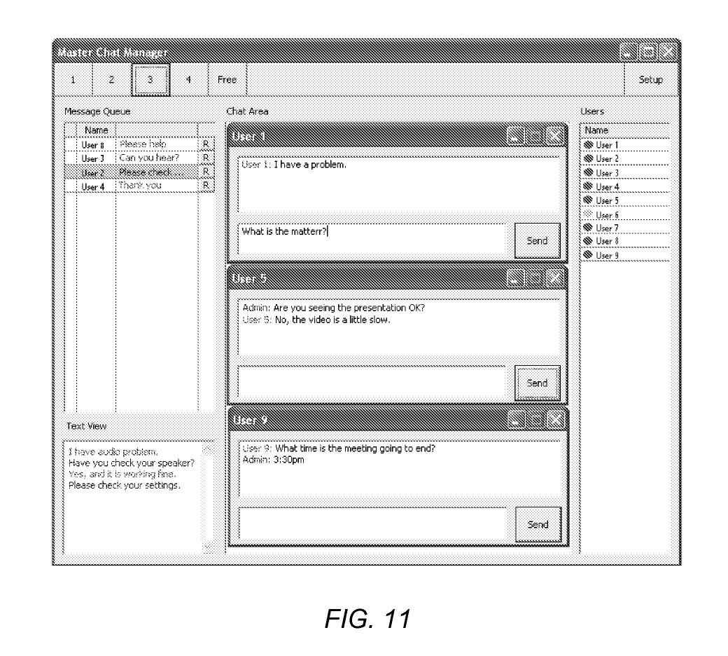

The multi-chat-session console has 4 major components: 1) Quick Layout Toolbar, 2) Message Queue Panel, 3) Quick Text View Panel, and 4) Managed chat area. FIG. 11 shows one potential implementation user interface (UI) for this application.

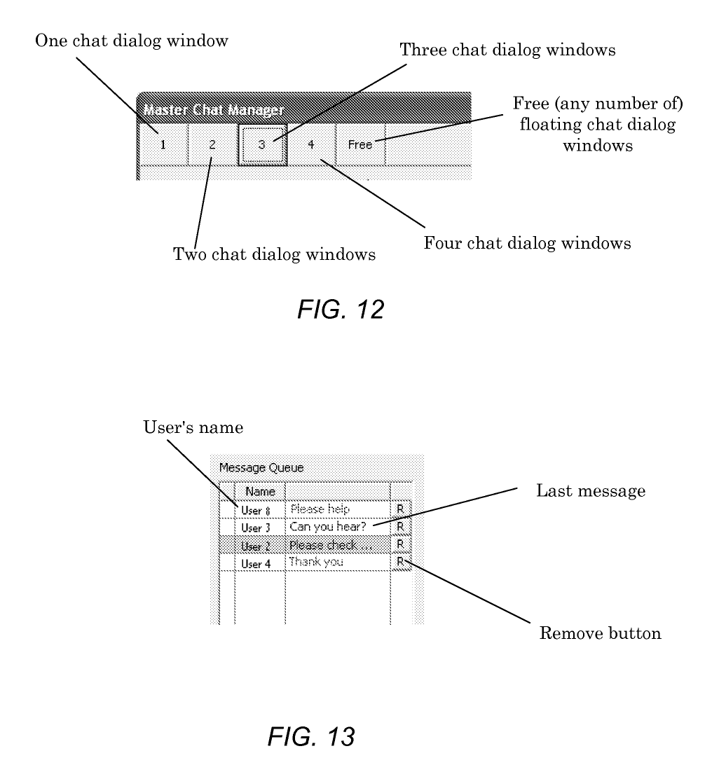

The Quick Layout Toolbar lets user quickly manage multiple chat session dialog windows in the chat area, as shown in FIG. 12.

When the administrator selects 1 chat dialog box layout, only 1 chat window appears over the chat area at most. The chat window in the chat area will be sized to fit the entire chat area. Similarly for 2, 3, and 4. Those are the maximum number of chat windows appears in the chat area. The entire chat area will be even divided by each chat window in the chat area.

The Message Queue Panel displays all of the participants who have text chat messages with the administrator not yet displayed on the chat area, as shown in FIG. 13. There are 3 components in this panel: 1) User's name, 2) the first part of the past sentence of the chat dialog, and 3) a “Remove” button which the administrator can remove an user from the message queue.

The user's name column indicates the user's name. The last message column indicates the first part of the last sentence between the administrator and the user. Since the last sentence of the dialog can either be from the administrator or the user, the console uses different color to indicate whom the last sentence belongs to. Blue is from the administrator and red is from the user. Of course, it is only an example. The administrator can setup a different color for this purpose.

The “Remove” button—” R is for the administrator to quickly remove a user from the Message Queue Panel. When the administrator thinks he/she is done with a certain user, the administrator can use this button to remove the user from the Message Queue.

When a user double clicks on an entry in the Message Queue Panel, the top most chat dialog window will be replaces with the chat window with the newly selected user. All of the original chat windows will get pushed down and the last chat window will be minimized back to the Message Queue Panel.

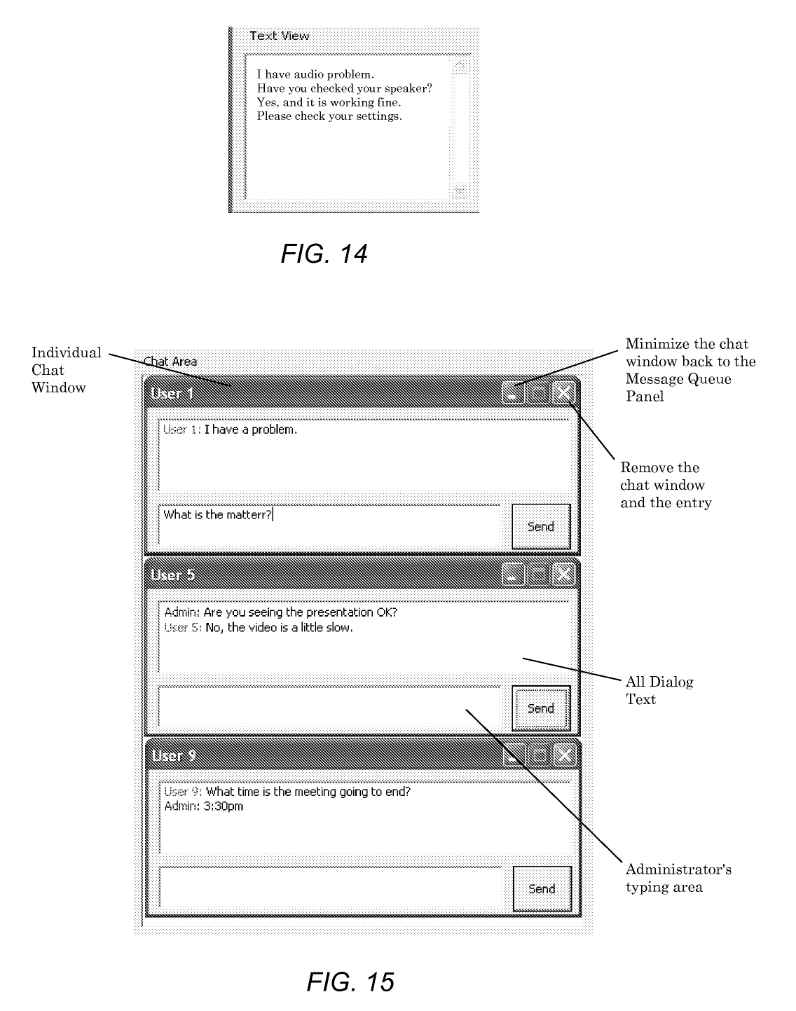

The Text View Panel displays the text messages for the selected high-lighted user's dialog with the administrator in the Message Queue Panel, as shown in FIG. 14.

In order to save space in the Text View Panel, user's message indicator will be color code only. Blue is for administrator and red is for the user. This way, we saved the space in front of each sentence that indicates which user this sentence belongs to.

From determining the selected entry in the Message Queue Panel, the currently selected entry's text dialogue will be displayed in the Text View Panel area. The user has color red and the administrator has color blue. All of the chat text data for each user is stored locally (but equally viable if stored in a remote server).

The Managed chat area is where the multi-chat-session console manages all of the text chat dialog windows, as shown in FIG. 15. Depending upon the layout setting, there can be zero to up to 4 chat dialog windows (can be higher if the product specification specifies that).

Each text-chat dialog window will be fixated to its relative position within the managed chat area. They aren't resizable inside the chat area. When user clicks on the minimize button on each dialog's upper right corner, the dialog box will be closed and a new entry will appear in the Message Queue for that user. However, if the administrator clicks on the close button on the upper right corner, the dialog will disappear but no entry will be created in the Message Queue Panel.

Based on the layout selected by the administrator, the console will resize and re-positions at most the selected layout number of chat windows to be anchored inside the Chat Area. All of the windows move/resize windows events for each individual window are ignored. When the console window is being moved, the positions of each individual chat windows inside the Chat Area will be re-calculated and rendered again.

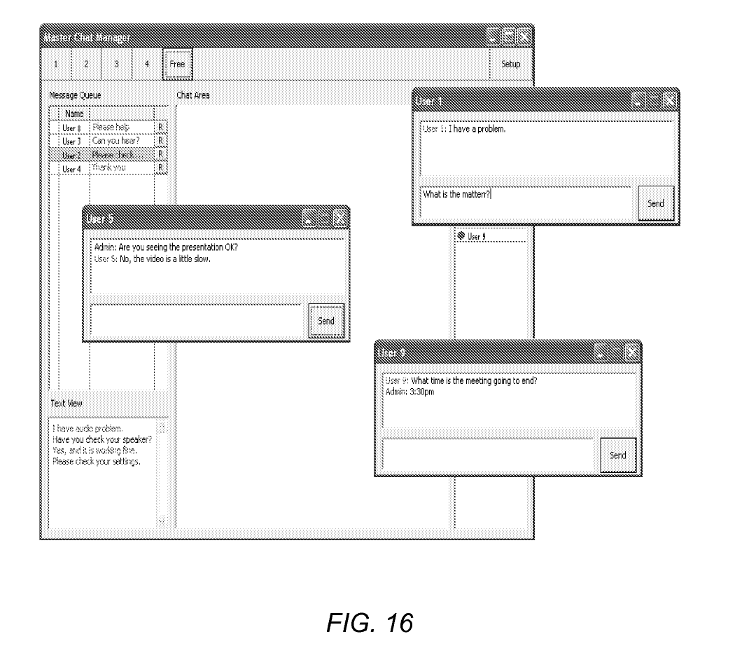

However, if the user chooses the “Free” layout, the administrator can select as many chat dialog windows, as he/she likes. All dialog windows are free to move anywhere on the desktop. In the “Free” mode, the chat windows are allowed to move independently from the multichat-session console's main window, as shown in FIG. 16.

When the administrator client on other predefined layout again, the individual chat windows will be put back into the chat are with the most recently chatted window placed on top.

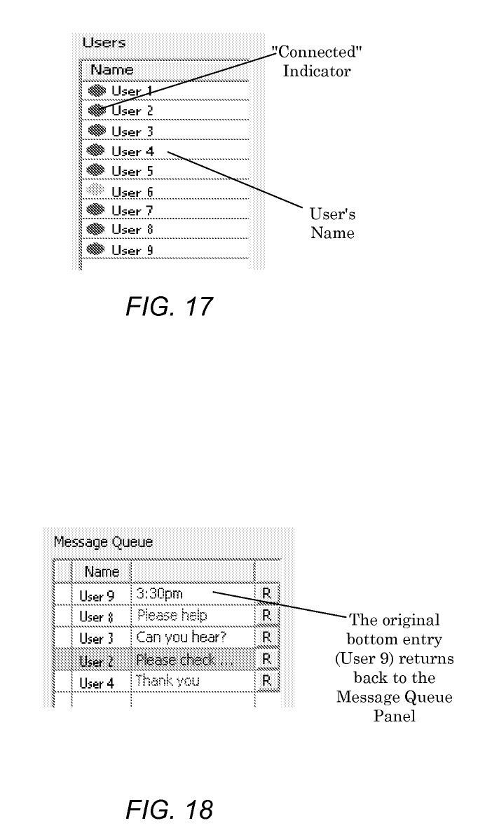

Another component of the multi-chat-session console is the Meeting Participant's Connection Status Panel. In case the administrator wants to initiate a chat session with a given user, he can double click on the user's entry that has a “connected” indicator (a solid red dot), as shown in FIG. 17.

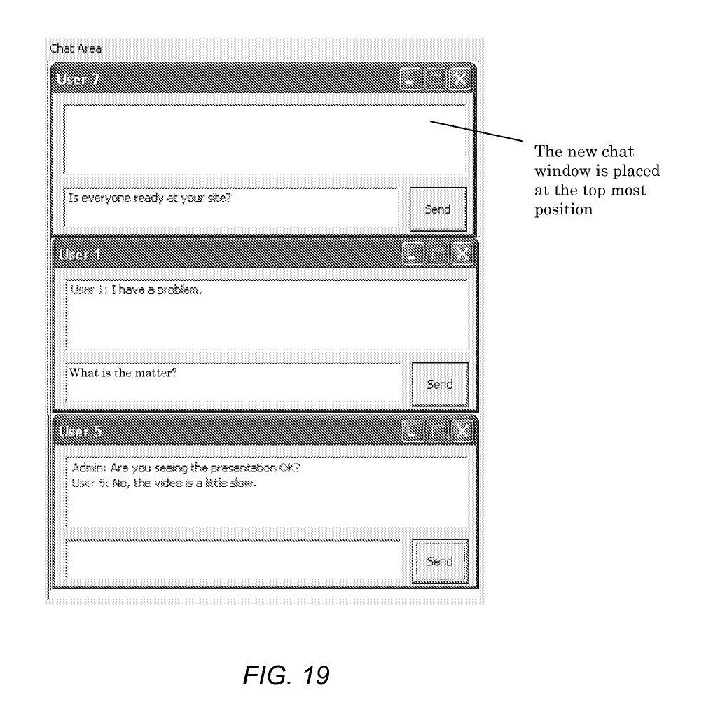

When this happens, like choosing a user session from the Message Queue Panel, a new dialog box will be created and place on top of the chat area. All of the existing dialog windows in the chat area will get pushed down one slot. And the dialog window at the bottom of the chat area will be minimized back to the Message Queue Panel, as shown in FIGS. 18-19.

This design gives us a way for a videoconference administrator to manage multiple conference participants chat sessions concurrently. The Message Queue Panel and the Chat Text View Panel together is a major feature that helps administrator juggles between different participant's chat session.

Many multi-chat management consoles have all of their individual chat windows as Frameviews (A Microsoft MFC framework). The problem with that approach is the individual chat windows are bounded within the general working area of the console application, instead of the entire desktop.

Embodiments provide a Message Queue Panel in which displays the first part of the last message between the user and the administrator in color code, a Message Queue Panel in which a quick remove button is provided for quick entry removal, a Message View Panel which displays the text of the exchanged dialog between the user and the administrator in color-coded format, a quick way for an individual chat window returns back to the Message Queue Panel, and a quick and easily accessible layout toolbar that let the administrator quick switched between different numbers of chat windows layout.

Some embodiments comprise a Master-Slave VoIP Data Management System Protocol. In some embodiments, an apparatus comprises: at least one first communication circuit to establish first management channels with a plurality of clients of a communication session comprising content channels for transporting audio data for the communication session and management channels for transporting management data for the communication session, wherein the content channels are separate from the management channels; a second communication circuit to establish a second management channel with a management server for the communication session; and a processor to establish a management proxy process for the communication session; wherein the management proxy process receives first management data from, and transmits second management data to, the clients over the first management channels for the communication session; wherein the management proxy process receives third management data from, and transmits fourth management data to, the management server over the second management channel for the communication session; and wherein the management proxy process generates the second management data based on the third management data, and generates the fourth management data based on the first management data.

Some embodiments comprise a memory to store state data describing one or more states of the communication session; wherein the management proxy process generates the second management data based on the third management data and the state data, and generates the fourth management data based on the first management data and the state data. Some embodiments comprise the management server. Some embodiments comprise: the clients. In some embodiments, the management proxy process acts as a server for each of the clients, and acts as a client for the management server. In some embodiments, the at least one first communication circuit establishes third management channels with a plurality of second clients of a second communication session comprising content channels for transporting audio data for the second communication session and management channels for transporting management data for the second communication session, wherein the content channels are separate from the management channels; wherein the processor establishes a second management proxy process for the second communication session; wherein the second management proxy process receives fifth management data from, and transmits sixth management data to, the second clients over the third management channels for the second communication session; wherein the second management proxy process receives seventh management data from, and transmits eighth management data to, the management server over the second management channel for the second communication session; and wherein the second management proxy process generates the sixth management data based on the seventh management data, and generates the eighth management data based on the fifth management data.

In a basic Server-based VoIP system, a single VoIP server can only handle a very limited number of VoIP client sessions concurrently. One possible solution is to offload some of the VoIP client sessions onto another (Slave) VoIP server and have all of those VoIP sessions bundle as one VoIP client session to the original (Master) VoIP server. This approach offloads some many of the CPU and bandwidth resource requirement from 1 server to many servers. As described below, the VoIP data management portion of such a system can work in the distributed VoIP system scheme above. In certain VoIP systems, there are 2 major components: 1) the audio/video data management component and 2) the meeting data management component. In a VoIP system, other than the actually audio/video data mixing, in many architectures, there is another component for handling meeting scheduling, user information management, VoIP session management, etc. Normally this management system has proprietary communication interface. In this case, a single TCP connection between the VoIP client and the Data management server.

In this Master-Slave VoIP data management system, one Meeting Proxy User represents all of the offloaded VoIP users. This Meeting Proxy User relays all of the necessary information between the offloaded VoIP clients and the Master VoIP data management server.

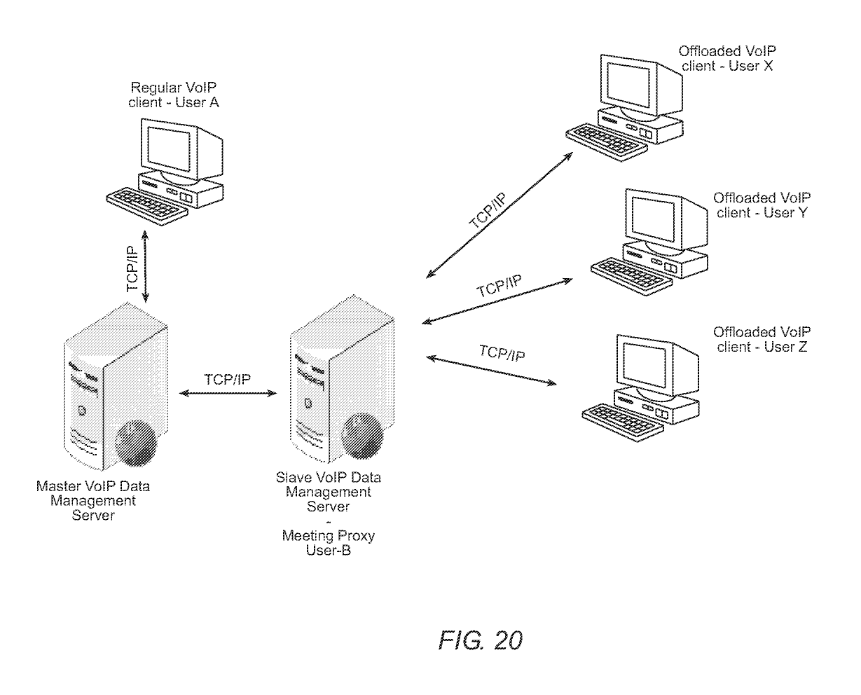

Referring to FIG. 20, the Master VoIP data management server thinks there are only 2 users connected to the meeting—User A and User B. The Slave VoIP data management serve thinks there are 3 users connected to the same meeting—User X, User Y, and User Z.

The Slave VoIP data management server accepts a TCP connection from the offloaded VoIP client. That initiates a VoIP data session to the Master VoIP data management server if one doesn't already exist.

The following are the steps involved when the first offloaded VoIP client contacts the Slave VoIP data management server:

1) Offloaded VoIP client (0-VC) makes a TCP connection to the Slave VoIP data management server (S-VDMS) and sends in login information like: user id, meeting id, and user password.

2) S-VDMS accepts 0-VC's connection and .reads the login data.

3) S-VDMS makes a TCP/IP connection to the Master VoIP data management server (M-VDMS) and sends user's login information over.

4) M-VDMS verifies is the user and password matches and is the user is allowed for the given meeting (identified by the meeting id).

5) M-VDMS sends back message to S-VDMS on either the user login is successful or not.

6) S-VDMS reads the user authentication responses and closes the TCP connection.

7) If the login is successful, S-VDMS checks is there an existing Meeting Proxy VoIP data session. If there is one, uses that Meeting Proxy session, else creates one.

For each S-VDMS, there is a dedicated VoIP user account assigned to it. When creating a VoIP meeting proxy data session, S-VDMS uses this dedicated user account for login and join a given meeting on the M-VDMS side.

As part of the regular VoIP user data session login protocol, each VoIP client will send over a JoinMeeting message and waits for the JoinMeetingAck message. The JoinMeetingAck message is followed by a number of meeting messages that initialize the client's initial states for the given meeting, like which slides is the presenter on, etc. For the Offloaded VoIP user data session, it follows the same protocol as the regular VoIP user data session. However, the S-VDMS handles the login data differently internally. The S-VDMS first verifies the user (as described in “Initiate VoIP meeting proxy data session” section above). Then S-VDMS checks is the there a meeting proxy session exists for that particular meeting. If not, S-VDMS will not process 0-VC's JoinMeeting message. Instead, create a meeting proxy session, sends JoinMeeting message using the dedicated S-VDMS user account information. S-VDMS user logs in as a regular VoIP participant at the M-VDMS side. M-VDMS sends back JoinMeetingAck message and follows by meeting initialization data messages to the SVDMS.

S-VDMS initializes its local meeting data management controller with the meeting initialization data messages from the M-VDMS side. Afterward, S-VDMS starts processing the JoinMeeting message from the 0-VC and sends back JoinMeetingAck and the meeting initialization data from the S-VDMS's local meeting data management controller.

During the session, all data sent from the M-VDMS is first intercepted and parsed by the S-VDMS. Then S-VDMS updates its local data management controller with the latest data. Afterward, S-VDMS will trigger appropriate messages to all (or subset of) connected 0-VCs using the information in the local data management controller. Messages from 0-VC will be distributed to other connected 0-VCs as usual. But the SVDMS will filter and modify some of the data of the O-VC messages before those messages get sent back to the M-VDMS side.

M-VDMS sends a “Ping” message to all of its connected clients every 5 seconds. When the S-VDMS receives the “Ping” message (act as a timer here), it checks is there any 0-VC still connected to the S-VDMS. If not, S-VDMS initiates a connection session close with the M-VDMS server and performs cleanup internally on the S-VDMS side.

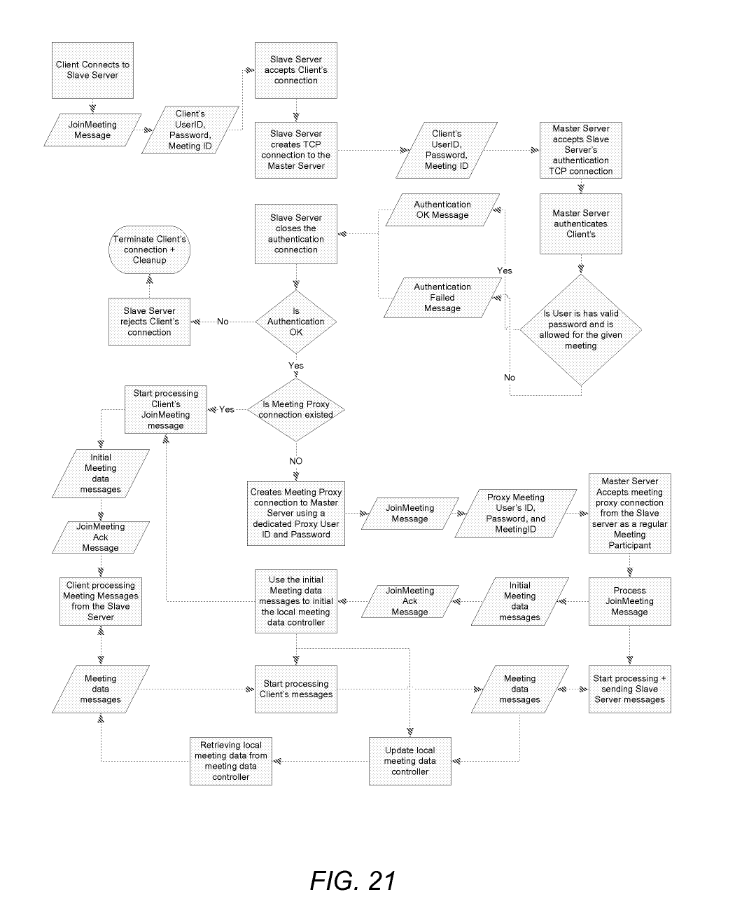

FIG. 21 shows a diagram for this detailed design.

This design gives scalability to handle more VoIP clients for a given meeting and can potentially cascade to have more master-slave-slave configuration in the future. It also masks the complexity from the regular VoIP client and the Master VoIP data management server. Embodiments provide a unique way of having one representative participant on behalf of a number of regular VoIP meeting participants, a separate connection for user login authentication, and a data buffer/re-processing scheme for relaying data between the Master Data Management server and the Offloaded VoIP clients.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

What is claimed is:

1. An apparatus comprising:
an input circuit to receive registration messages from virtual meeting servers, wherein each registration message comprises a network address of the respective virtual meeting server and an identification string for the respective virtual meeting server;
a memory to store an association for each of the virtual meeting servers between the respective network addresses and the respective identification strings;
wherein the input circuit receives virtual meeting invitation acceptance messages, wherein each virtual meeting invitation acceptance message comprises one of the identification strings;
a processor to select the network addresses associated with the identification strings in the virtual meeting invitation acceptance messages; and
an output circuit to transmit a redirect message in response to each of the virtual meeting invitation acceptance messages, wherein each of the redirect messages comprises the network address associated with the identification string in the corresponding virtual meeting invitation acceptance message.

2. The apparatus of claim 1, wherein the network address comprises:
a dynamic Internet Protocol (IP) address.

3. The apparatus of claim 2:
wherein, when one of the registration messages comprises an identification string for one of the virtual meeting servers having a corresponding one of the associations stored in the memory, the processor replaces the dynamic IP address in the one of the associations with the dynamic IP address of the virtual meeting server from the one of the registration messages.

4. The apparatus of claim 2:
wherein, when one of the registration messages comprises an identification string for one of the virtual meeting servers not having a corresponding one of the associations stored in the memory, the processor stores, in the memory, an association between the dynamic IP address of the virtual meeting server from the one of the registration messages and the identification strings from the one of the registration messages.

5. The apparatus of claim 2, wherein the virtual meeting comprises:
a videoconference.

6. A method comprising:
receiving registration messages from virtual meeting servers, wherein each registration message comprises a network address of the respective virtual meeting server and an identification string for the respective virtual meeting server;
storing an association for each of the virtual meeting servers between the respective network addresses and the respective identification strings;
receiving virtual meeting invitation acceptance messages, wherein each virtual meeting invitation acceptance message comprises one of the identification strings;
selecting the network addresses associated with the identification strings in the virtual meeting invitation acceptance messages; and
transmitting a redirect message in response to each of the virtual meeting invitation acceptance messages, wherein each of the redirect messages comprises the network address associated with the identification string in the corresponding virtual meeting invitation acceptance message.

7. The method of claim 6, wherein the network address comprises:
a dynamic Internet Protocol (IP) address.

8. The method of claim 7, further comprising:
when one of the registration messages comprises an identification string for one of the virtual meeting servers having a corresponding one of the associations, replacing the dynamic IP address in the one of the associations with the dynamic IP address of the virtual meeting server from the one of the registration messages.

9. The method of claim 7, further comprising:
when one of the registration messages comprises an identification string for one of the virtual meeting servers not having a corresponding one of the associations, storing an association between the dynamic IP address of the virtual meeting server from the one of the registration messages and the identification strings from the one of the registration messages.

10. The method of claim 7, wherein the virtual meeting comprises:
a videoconference.

11. An apparatus comprising:
a processor to host a virtual meeting; and
an output circuit to transmit a registration message to a discovery server, wherein the registration message comprises a first network address assigned to the discovery server, a second network address assigned to the apparatus, and an identification string assigned to the apparatus;
wherein the output circuit transmits virtual meeting invitation messages to virtual meeting clients, wherein each of the virtual meeting invitation messages comprises an identifier of the virtual meeting, the first network address of the discovery server, and the identification string.

12. The apparatus of claim 11:
wherein the first network address comprises a static Internet Protocol (IP) address; and
wherein the second network address comprises a dynamic IP address.

13. The apparatus of claim 12:
wherein the processor generates a uniform resource locator (URL) comprising the identification string, and having the static IP address assigned to the discovery server as the target of the URL; and
wherein each of the virtual meeting invitation messages comprises the URL.

14. The apparatus of claim 12:
wherein the processor determines whether any identification string is assigned to the apparatus, and, when no identification string is assigned to the apparatus, generates a new identification string, and assigns the new identification string to the apparatus.

15. The apparatus of claim 12, wherein the virtual meeting comprises:
a videoconference.

16. The apparatus of claim 12:
wherein the apparatus obtains the dynamic IP addresses using Dynamic Host Configuration Protocol (DHCP).

17. A method comprising:
hosting a virtual meeting;
transmitting a registration message to a discovery server, wherein the registration message comprises a first network address assigned to the discovery server, a second network address assigned to a computer executing the instructions, and an identification string assigned to the computer; and
transmitting virtual meeting invitation messages to virtual meeting clients, wherein each of the virtual meeting invitation messages comprises an identifier of the virtual meeting, the first network address of the discovery server, and the identification string.

18. The method of claim 17:
wherein the first network address comprises a static Internet Protocol (IP) address; and
wherein the second network address comprises a dynamic IP address.

19. The method of claim 18, further comprising:
generating a uniform resource locator (URL) comprising the identification string, and having the static IP address assigned to the discovery server as the target of the URL;
wherein each of the virtual meeting invitation messages comprises the URL.

20. The method of claim 18, further comprising:
determining whether any identification string is assigned to the computer, and, when no identification string is assigned to the computer, generates a new identification string, and assigns the new identification string to the computer.

21. The method of claim 18, wherein the virtual meeting comprises:
a videoconference.

22. The method of claim 18, further comprising:
obtaining the dynamic IP addresses using Dynamic Host Configuration Protocol (DHCP)
